(19) United States
(12) Patent Application Publication
(10) Pub. No.: US 2015/0256475 A1
(43) Pub. Date: Sep. 10, 2015

(54) SYSTEMS AND METHODS FOR DESIGNING AN OPTIMIZED INFRASTRUCTURE FOR EXECUTING COMPUTING PROCESSES

(71) Applicants: Abhishek Suman, Nalanda (IN); Sumanta Laha, Begampur (IN)

(72) Inventors: Abhishek Suman, Nalanda (IN); Sumanta Laha, Begampur (IN)

(73) Assignee: Wipro Limited, Bangalore (IN)

(21) Appl. No.: 14/255,375

(22) Filed: Apr. 17, 2014

(30) Foreign Application Priority Data
Mar. 5, 2014 (IN) 1135/CHE/2014

(51) Int. Cl. H04L 12/911; G06F 9/50

(52) U.S. Cl. CPC H04L 47/70; G06F 9/5005; G06F 9/5027; G06F 9/5072

(57) ABSTRACT

This disclosure relates generally to optimizing computing resources and, more particularly, to systems and methods for dynamically determining an optimized infrastructure for processing data. In one embodiment, a method for dynamically determining an optimized infrastructure for processing data is disclosed, comprising: receiving a task-processing request. The method may also include identifying, based on the received task-processing request, one or more rules associated with performing the task-processing request. The method may further include accessing historical learning information associated with performing at least one past task-processing request. The method may further include allocating computing resources for performing the task-processing request based on the identified one or more rules, accessed historical learning information, and available computing resources associated with a distributed computing environment. The method may further include determining the optimized infrastructure based on the allocated computing resources.

### PRIORITY CLAIM

This U.S. patent application claims priority under 35 U.S.C. §119 to India Patent Application No. 1135/CHE/2014, filed on Mar. 5, 2014. The aforementioned application is incorporated herein by reference in its entirety.

### TECHNICAL FIELD

This disclosure relates generally to optimizing computing resources and, more particularly, to systems and methods for dynamically determination of an optimized infrastructure for processing data.

### BACKGROUND

For executing computing processes, a user may access computing resources as needed without regarding the nature of the computing resources or the access method. For example, the nature of the computing resources may be physical, virtual, dedicated, or shared. The user may access the computing resource via a direct network connection, a Local Area Network (LAN), a Wide Area Network (WAN), the Internet, or a cloud environment. Regardless of the nature of the computing resources or the access method, the computing resources typically appear to a user as a single pool of unified resources, which may include computing devices (e.g., servers, clusters, and grids), memory devices, storage devices, etc.

Often times, depending on the data size associated with execution of the computing processes, a user (e.g., a business user, a developer, etc.) may be required to determine the computing resources allocation. For example, the user may need to determine whether the required computing resources should include one or more of parallel big data platforms, sequential statistical tools, local databases, etc. Based on the available computing resources, the data size, and the requirements for executing the computing processes, the user may be required to manually estimate and design the infrastructure for processing the data, which can be non-trivial and often times result in a non-optimized infrastructure.

The manual process of estimating and designing the infrastructure may be further complicated if executing multiple computing processes is required. For determining an infrastructure in such a situation, the user typically creates separate modules for each of the required computing processes, configures nodes for each cluster (e.g., a group of operatively connected computers), and integrates all the modules and nodes to determine the infrastructure. After the infrastructure is determined, the user may then execute the computing processes using the infrastructure and may be required to periodically monitor the infrastructure status.

Often times, in manually designing and estimating the infrastructure, a user may not have a thorough knowledge of the computing resources available because the user is usually not exposed to such information. As a result, when the user manually defines the process flow and the logical aspects of the infrastructure, the user may find it difficult, cumbersome, and time consuming. Additionally, the user may fail to identify and consider all the correlated issues with respect to the execution of the computing processes.

### SUMMARY

In one embodiment, a method for dynamically determining an optimized infrastructure for processing data is disclosed, comprising: receiving a task-processing request. The method may also include identifying, based on the received task-processing request, one or more rules associated with performing the task-processing request. The method may further include accessing historical learning information associated with performing at least one past task-processing request. The method may further include allocating computing resources for performing the task-processing request based on the identified one or more rules, accessed historical learning information, and available computing resources associated with a distributed computing environment. The method may further include determining the optimized infrastructure based on the allocated computing resources.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network system, according to some embodiments of the present disclosure.

FIG. 2A is an exemplary functional block diagram of a computing environment including a system for dynamically determining an optimized infrastructure for processing data, according to some embodiments of the present disclosure.

FIG. 2B is an exemplary functional block diagram of a learning and rules module, according to some embodiments of the present disclosure.

FIG. 2C is an exemplary functional block diagram of a computing resources optimizer, according to some embodiments of the present disclosure.

FIG. 3 is a flow diagram illustrating an exemplary method for dynamically determining an optimized infrastructure for processing data, consistent with some embodiments of the present disclosure.

FIG. 4A is a flow diagram illustrating an exemplary method for estimating required computing resources, consistent with some embodiments of the present disclosure.

FIG. 4B is a flow diagram illustrating an exemplary method for determining required computing processes, consistent with some embodiments of the present disclosure.

FIG. 5A is a flow diagram illustrating an exemplary method for providing an optimized infrastructure for performing the task-processing request, consistent with some embodiments of the present disclosure.

FIG. 5B is a flow diagram illustrating an exemplary method for performing the task-processing request using an optimized infrastructure, consistent with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

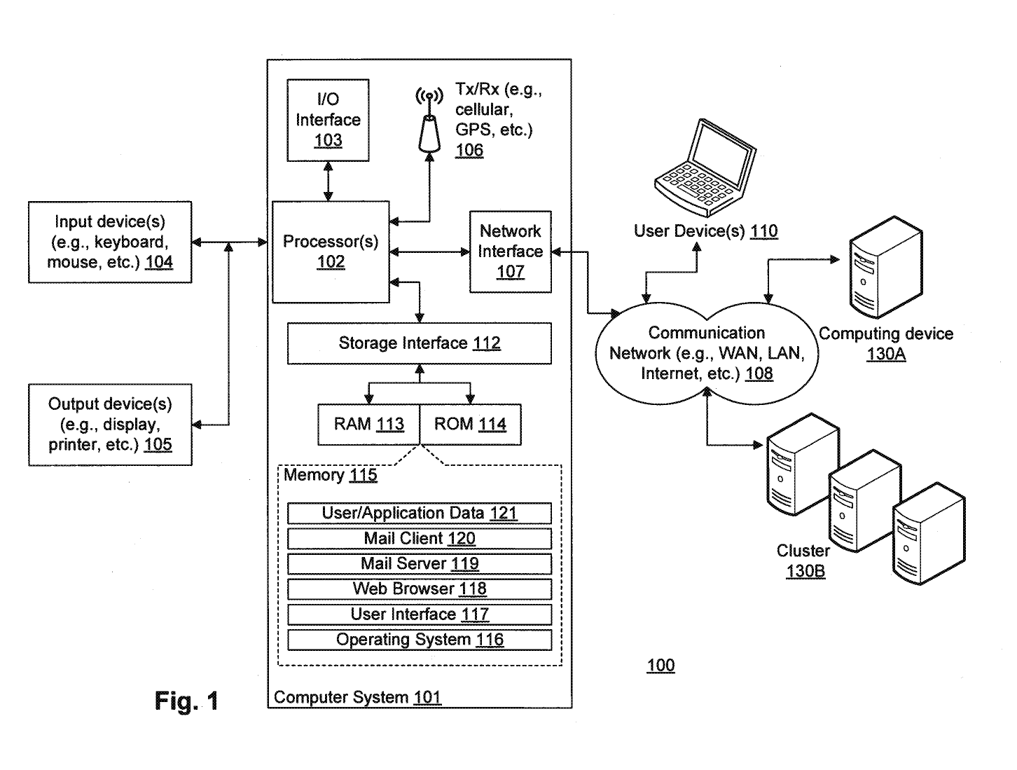

FIG. 1 is a block diagram of an exemplary network system 100 for implementing embodiments consistent with the present disclosure. Variations of computer system 101 may be used for implementing a server, such as a content server, a proxy server, a webserver, a desktop computer, a server farm, etc. Computer system 101 may comprise one or more central processing units (“CPU” or “processor”) 102. Processor 102 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 102 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 102 may be disposed in communication with one or more input/output (I/O) devices via I/O interface 103. I/O interface 103 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 103, computer system 101 may communicate with one or more I/O devices. For example, input device 104 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 105 may be a printer, fax machine, video display (e.g., cathode ray tube (CRT), liquid crystal display (LCD), light-emitting diode (LED), plasma, or the like), audio speaker, etc. In some embodiments, a transceiver 106 may be disposed in connection with the processor 102. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 102 may be disposed in communication with a communication network 108 via a network interface 107. Network interface 107 may communicate with communication network 108. Network interface 107 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 108 may include, without limitation, a direct interconnection, local area network (LAN), wide area network (WAN), wireless network (e.g., using Wireless Application Protocol), the Internet, etc. Using network interface 107 and communication network 108, computer system 101 may communicate with user devices 110. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 101 may itself embody one or more of these devices.

In some embodiments, using network interface 107 and communication network 108, computer system 101 may communicate with computing device 130A and/or cluster 130B. Computing device 130A may be any device that may perform a computing process. For example, computing device 130A may a desktop computer or a server. Cluster 130B may be a group of computing devices (e.g., servers or a server farm) that are operatively connected for performing computing processes. For example, cluster 130 B may be a group of servers connected to work in a distributed computing environment to perform one or more computing processes.

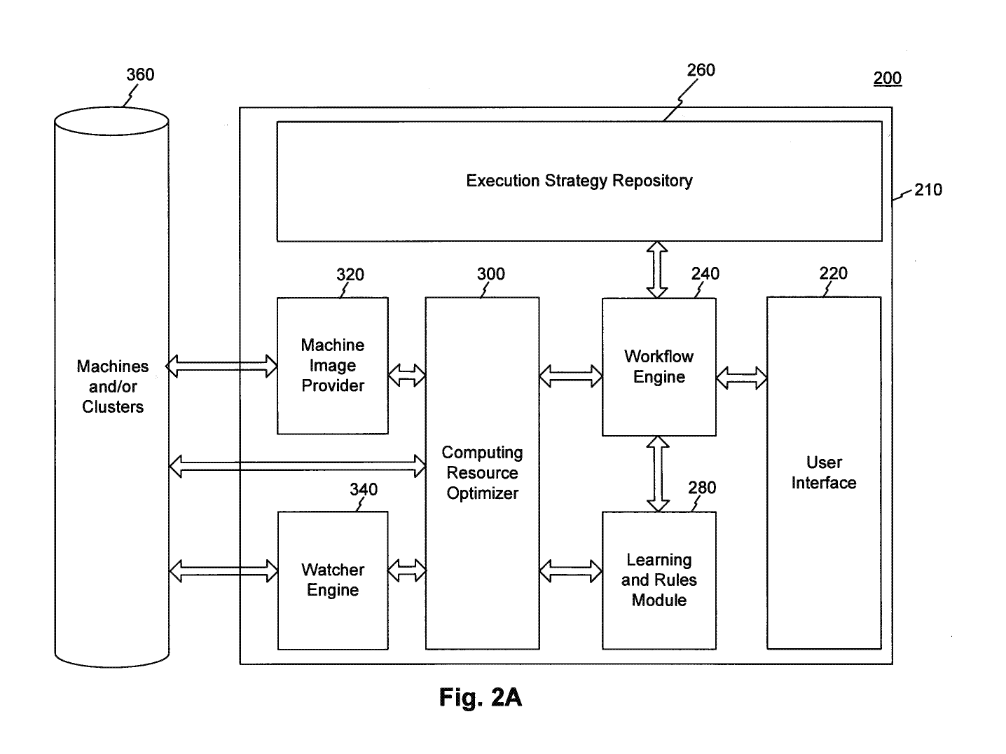

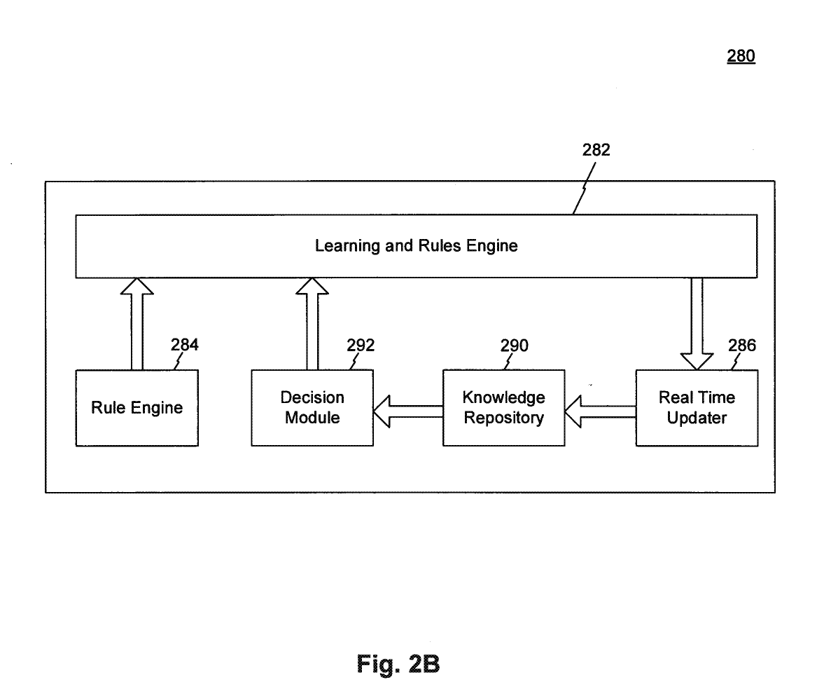

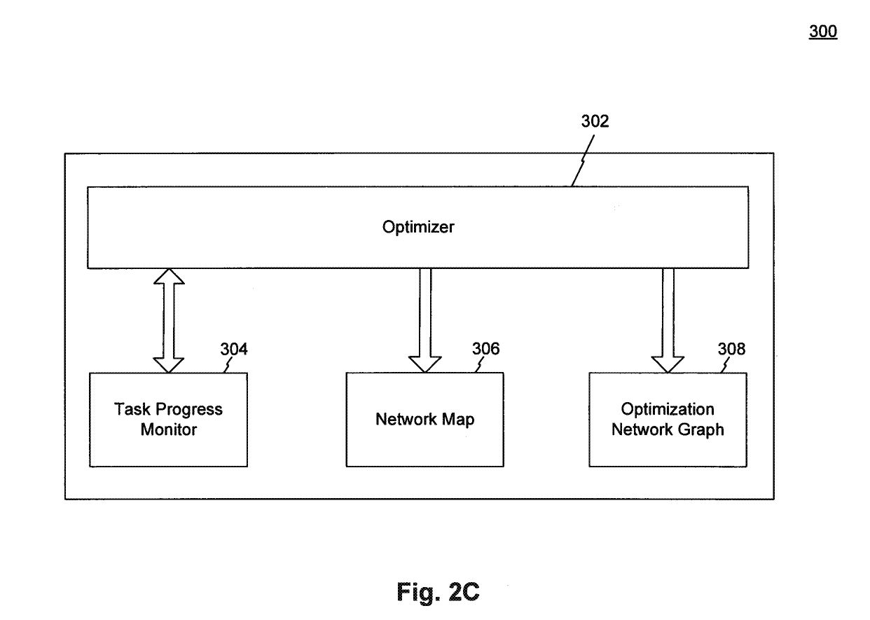

In some embodiments, processor 102 may be disposed in communication with one or more memory devices (e.g., RAM 113, ROM 114, etc.) via a storage interface 112. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, one or more components, such as workflow engine 240, learning and rules module 280, and computing resource optimizer 300, as shown in FIG. 2A.

The memory devices may store a collection of program or database components, including, without limitation, an operating system 116, user interface application 117, web browser 118, mail server 119, mail client 120, user/application data 121 (e.g., any data variables or data records discussed in this disclosure), etc. Operating system 116 may facilitate resource management and operation of computer system 101. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 117 may facilitate display, execution, interaction, manipulation, or operation of program components through textual or graphical facilities. For example, user interfaces may provide computer interaction interface elements on a display system operatively connected to computer system 101, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 101 may implement a web browser 118 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 101 may implement a mail server 119 stored program component. Mail server 119 may be an Internet mail server such as Microsoft Exchange, or the like. Mail server 119 may utilize facilities such as ASP, ActiveX, ANSI C++/C#, Microsoft .NET, CGI scripts, Java, JavaScript, PERL, PHP, Python, WebObjects, etc. Mail server 119 may utilize communication protocols such as internet message access protocol (IMAP), messaging application programming interface (MAPI), Microsoft Exchange, post office protocol (POP), simple mail transfer protocol (SMTP), or the like. In some embodiments, computer system 101 may implement a mail client 120 stored program component. Mail client 120 may be a mail viewing application, such as Apple Mail, Microsoft Entourage, Microsoft Outlook, Mozilla Thunderbird, etc.

In some embodiments, computer system 101 may store user/application data 121, such as the data, variables, records, etc. (e.g., record of transactions, response objects, response chunks) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Disclosed embodiments describe systems and methods for dynamically determining an optimized infrastructure for processing data. The illustrated components and steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

FIG. 2A is an exemplary functional block diagram of a computing environment 200 including a system 210 for dynamically determining an optimized infrastructure for processing data, according to some embodiments of the present disclosure. With reference to FIG. 2A, in some embodiments, computing environment 200 may include system 210 and machines and/or clusters 360. Computing environment 200 may be, for example, a distributed computing environment. System 210 may include a user interface 220, a workflow engine 240, an execution strategy repository 260, a learning and rules module 280, a computing resource optimizer 300, a machine image provider 320, and a watcher engine 340.

System 210 may be implemented by, for example, computer system 101. Machines and/or clusters 360 may include, for example, one or more of computing devices 130A (e.g., one or more servers) and/or one or more of clusters 130B (e.g., clusters of servers). System 210 may communicate with machines and/or clusters 360 directly or indirectly. For example, system 210 may request machines and/or clusters 360 to perform certain computing processes and interact with machines and/or clusters 360 (e.g., receiving results of executed processes). System 210 may communicate with one or more user devices either directly or indirectly. For example, system 210 may communicate, via user interface 220, with user device 110 to receive a task-processing request. System 210 can be a software program and/or a hardware device.

With reference to FIG. 2A, in some embodiments, user interface 220 may enable system 210 to receive input from a user, such a task-processing request or a request for executing one or more computing processes. User interface 220 may receive information associated with, for example, one or more computing processes for performing the task-processing request, an order of execution with respect to the one or more computing processes, and/or a plurality of task-processing requirements.

As an example, a user may desire to perform analysis on a brand persona, i.e., a 360 degree view of various products and services associated with the brand. For performing the brand persona analysis, one or more computing processes may be required. The computing processes may include, for example, collecting and/or extracting relevant data from various sources like social media websites and blogs, filtering the collected unstructured data and performing an extract-transform-load (ETL) process on the unstructured data, and performing consumer behavior analysis on the transformed data corresponding to the various products and services. The consumer behavior analysis may be performed using text mining algorithms (e.g., the bag-of-words model). The computing processes may also include performing segmentation based on extracted sentiments corresponding to various products and services using machine learning algorithms (e.g., multi-class classifier). The computing processes may also include storing the analyzed data in a structured format in a data store (e.g., a MongoDB database) to provide readability and visualization.

In some embodiments, user interface 220 may receive information associated with one or more computing processes for processing the task-processing request. For example, as described above, corresponding to the user's request to perform a brand persona analysis, user interface 220 may receive a user's description or selection of a social media extraction process, a crawling process, a data filtering process, an ETL process, a sentiment analysis, and/or a user-defined process. The computing processes will be further described below.

User interface 220 may also receive task-processing request containing information indicating the order of executing the one or more computing processes. For example, the task-processing request may indicate that the order of executing the computing processes for a brand persona analysis may be in the order of executing a social media extraction process, following by a crawling process, followed by a data filtering process, followed by an ETL process, followed by a sentiment analysis, followed by a user-defined process. In some embodiments, user interface 220 may also receive a plurality of the task-processing requirements. For example, user interface 220 may receive detailed requirements associated with executing the one or more computing processes (e.g., specific parameters of the computing processes).

As shown in FIG. 2A, system 210 may include a workflow engine 240. Workflow engine 240 may obtain information associated with the task-processing request from user interface 220. For example, workflow engine 240 may obtain the information associated with one or more computing processes for performing the task-processing request. As described above, the information associated with one or more computing processes may include description of the one or more computing processes, such as a social media extraction process, a crawler process, a data filtering process, an ETL process, a sentiment analysis, and/or a user-defined process. After obtaining the information, workflow engine 240 may determine that the computing processes indicated in the obtained information correspond to available computing processes in execution strategy repository 260.

In some embodiments, execution strategy repository 260 may provide one or more available computing processes. The available computing processes may be predefined computing processes, such as a social media extraction process, a crawling process, a data filtering process, an ETL process, a sentiment analysis, a log analyzing process, and/or a recommendation process. For example, a social media extraction process may collect data from a plurality of data sources like social media websites, blogs, twittering tools, etc. A crawling process may systematically browse the Internet (e.g., visit various Universal Resource Locaters) for preconfigured purposes, such as indexing or updating the web contents. In some embodiments, a crawling process may also copy the visited webpages for later processing by a search engine that indexes the downloaded webpages so that searching of the webpages may be expedited.

A data filtering process may process the unstructured data through preconfigured or predefined data filters so to extract information from the unstructured data and transform it into structured data for subsequent use. A data filtering process may use any type of data mining technologies, including anomaly detection, association rule learning, clustering, classification, regression, and/or summarization.

An ETL process may extract data from external sources, transform the extracted data to meet operational requirements, and/or load the extracted data into the end target. For example, an ETL process may extract data from various data source systems that may have different data organization and/or data source format. Examples of different data source format may include relational databases or non-relational database structures such as information management system (IMS), virtual storage access method (VSAM), and indexed sequential access method (ISAM). In some embodiments, an ETL process may parse the extracted data and determine whether the data meets an expected pattern or structure.

An ETL process may also transform the data by applying a plurality of rules or functions to the extracted data from the source to prepare the data for loading into the end target (e.g., loading into a target database to meet the business and technical requirements of the target database). In some embodiments, transformation of the data may require no or minimum manipulation of the data. In some embodiments, transformation of the data may require, for example, selecting only certain rows or columns of the data to load, translating coded values, encoding free-form values, deriving new calculated values, sorting, ranking, joining data from multiple sources and de-duplicating the data, aggregation, generating surrogate-key values, transposing or pivoting, splitting a column of the data into multiple columns, looking-up and validating the relevant data from tables or referential files for slowly changing dimensions, and/or applying any form of simple or complex data validation.

An ETL process may also load the transformed data into the end target, e.g., a data warehouse. In some embodiments, an ETL process may load the data to overwrite existing information with cumulative information (e.g., updating the information stored in the data warehouse). In some embodiments, an ETL process may load the data to add new data in a historical form. The new data may be added at regular intervals or at any desired time.

A sentiment analysis may also be referred to as opinion mining. A sentiment analysis may use various analytics tools (e.g., natural language process, text analysis, and/or computational linguistics) to identify and extract subjective information in data sources. A sentiment analysis may determine the attitude of a speaker or a writer with respect to some topic or the overall contextual polarity of a document. The attitude may be the speaker or the writer's judgment or evaluation, affective state (e.g., the emotional state of the writer when he or she is writing), or the intended emotional communication (e.g., the emotional effect the writer wishes to have on the reader). For example, a sentiment analysis may be an automated sentiment analysis of digital texts, using machine learning techniques such as latent semantic analysis, support vector machines, “bag of words” and Semantic Orientation-Pointwise Mutual Information. A sentiment analysis may be manual or automated. A sentiment analysis may use open source software tools involving machine learning, statistics, and natural language processing techniques to automate the analysis of large collections of texts, including web pages, online news, internet discussion groups, online reviews, web blogs, and social media websites. A sentiment analysis may also use knowledge-bases systems involving publicly available resources, e.g., WordNet-Affect, SentiWordNet, and SenticNet, to extract the semantic and affective information associated with natural language concepts.

A log analyzing process may process computer-generated or user-generated logs, such as logs files or log messages (e.g., audit records, event-logs, web-site visiting logs, etc.). A log analyzing process may collect logs, parse log files or log messages, analyze logs, aggregate logs, and retain logs for future references. A recommendation process may provide one or more recommendations based on historical data, e.g., a user's past behavior. A recommendation process may use collaborative techniques and/or content-based filtering techniques to provide the recommendations. For example, using the collaborative filtering techniques, a recommendation process may build a model from a user's past behavior (e.g., items previously purchased or selected and/or numerical ratings given to those items) and similar decisions made by other users, and use that model to predict items (or ratings for items) that the user may have an interest in. Using the content-based filtering techniques, a recommendation process may utilize a series of discrete characteristics of an item in order to recommend additional items with similar properties.

Execution strategy repository 260 may indicate that the user-defined computing processes are also available. A user-defined computing process may be a user-specified task available in the pool of computing processes in execution strategy repository 260. A user-specified task may be different from the predefined computing processes as described above, may be variations of the predefined computing processes, or may be a combination of the predefined computing processes. In some embodiments, execution strategy repository 260 may enable user interface 220 to provide the available computing processes to the user.

As described above, workflow engine 240 may obtain the information associated with the task-processing request. The information may indicate one or more computing processes for performing the task-processing request. After obtaining such information, workflow engine 240 may determine that the one or more computing processes indicated in the information correspond to the available computing processes in execution strategy repository 260. For example, user interface 220 may receive a task-processing request including descriptions or selections of a social media extraction process and sentiment analysis. Based on the descriptions or selections, workflow engine 240 may determine that the social media extraction process and the sentiment analysis correspond to available computing processes as indicated by execution strategy repository 260.

In some embodiments, workflow engine 240 may determine the order of executing the one or more required computing processes determined available. For example, workflow engine 240 may determine that the computing processes indicated in the task-processing request correspond to the sentiment analysis, the data filtering process, and the social media extraction process, all three of which are available processes and require computing processes for performing the task-processing request. The information associated with the task-processing request may also indicate the order of executing the one or more required computing processes. Based on the information, workflow engine 240 may determine that the order of executing these required computing processes are to execute the social media extraction process, followed by the data filtering process, followed by the sentiment analysis.

In some embodiments, workflow engine 240 may also determine the process flow configuration (e.g., connections of the inputs and outputs of the computing processes). For example, workflow engine 240 may determine that the output of the social media extraction process should be the input of the data filtering process, and the output the data filtering process should be the input of the sentiment analysis. In some embodiments, the input and/or output of one required computing process may also be connected to the input and/or output of two or more required computing processes. For example, the output a data filtering process may be connected to the input of a sentiment analysis and the input of an ETL process.

As shown in FIG. 2A, system 210 may include a learning and rules module 280. Based on the one or more required computing processes provided by workflow engine 240, learning and rules module 280 may identify one or more rules associated with performing the task-processing request that are received via user interface 220. Learning and rules module 280 may also identify and access historical learning information. Based on at least one of the identified historical learning information and the rules associated with performing the task-processing request, learning and rule module 218 may estimate the required computing resources for executing the one or more required computing processes determined by workflow engine 240. Learning and rule module 218 may also store the identified historical learning information in a knowledge repository.

In some embodiments, learning and rules module 280 may provide the estimated required computing resources to workflow engine 240 and/or computing resource optimizer 300. Using the estimated required computing resources, workflow engine 240 and/or computing resource optimizer 300 may allocate computing resources for performing the one or more required computing processes and determine an optimized infrastructure based on the allocated computing resources. Details of learning and rules module 280 and computing resource optimizer 300 will be further described below.

System 210 may include a machine image provider 320. Machine image provider 320 may provide one or more images including at least an operating system and software corresponding to one or more virtual machines associated with the allocated computing resources. In some embodiments, machine image provider 320 may obtain the optimized infrastructure from computing resource optimizer 300. Based on the optimized infrastructure, which may indicate the allocation of the computing resources, machine image provider 320 may provide images to the allocated computing resources. The provided images may include, for example, operating systems and software corresponding to the virtual machines of allocated computing resources of machines and/or clusters 360. The software may include, for example, Hadoop ecosystem, SQL databases, NoSQL databases, etc. In some embodiments, machine image provider 320 may provide images including the software that are installed with the operating systems.

As shown in FIG. 2A, machine image provider 320 may load the optimized infrastructure to one or more virtual machines associated with the allocated computing resources. For example, computing resource optimizer 300 may instruct machine image provider 320 to boot the correct images to the allocated computing resources (e.g., virtual machines of a plurality of servers of machines and/or clusters 360) and load the optimized infrastructure to the allocated computing resources. The optimized infrastructure may indicate, for example, the one or more required computing processes and their corresponding allocated virtual machines/servers/clusters. After machine image provider 320 loads the optimized infrastructure to the allocated computing resources, computing resource optimizer 300 may request the allocated computing resources to execute the one or more required computing processes for performing the task-processing request.

In FIG. 2A, system 210 may also include a watcher engine 340. Watcher engine 340 may monitor the availability and/or parameters associated with computing resources (e.g., machines and/or clusters 360) in computing environment 200. For example, watcher engine 340 may be a scalable distributed monitoring system for high-performance computing systems including, for example, clusters or grids of computing devices. Watcher engine 340 may monitor and provide to computing resource optimizer 300 the operating status of the available computing resources. The operating status of the available computing resources including at least one of: current states of the available computing resources, one or more processor-related current utilization parameters, one or more memory-related current utilization parameters, one or more disk related current utilization parameters, and one or more network-related current traffic parameters. In some embodiments, watcher engine 340 may provide the data associated with monitoring of the availability and/or parameters of the computing resources to computing resource optimizer 300. Based on such data, computing resource optimizer 300 may be enabled to predict the availability and/or health of the computing resources in computing environment 200, and thus dynamically identify available computing resources and allocate the computing resources for performing a task-processing request.

In some embodiments, after the allocated computing resources in machines and/or clusters 360 complete the execution of the required computing processes, watcher engine 340 may also provide data associated with such execution to computing resource optimizer 300 and/or learning and rules module 280. For example, watcher engine 340 may provide data associated with processor usage parameters, resource utilization parameters, etc. to computing resource optimizer 300, which may in turn provide the data to learning and rules module 280 to update the knowledge repository. In some embodiments, computing resource optimizer 300 may provide data associated with execution of the required computing processes directly to learning and rules module 280.

FIG. 2B is an exemplary functional block diagram of a learning and rules module 280, according to some embodiments of the present disclosure. Learning and rules module 280 may include a learning and rule engine 282, a rule engine 284, a real time updater 286, a knowledge repository 290, and a decision module 292.

With reference to FIG. 2B, learning and rule engine 282 may enable learning and rules module 280 to communicate with other components of a system for dynamically determining an optimized infrastructure (e.g., workflow engine 240 and/or computing resource optimizer 300 of system 210). As described above, workflow engine 240 may determine the required computing processes based on the information associated with the task-processing request and provide the required computing processes to learning and rules module 280. Thus, via learning and rule engine 282, learning and rules module 280 may obtain the required computing processes provided by workflow engine 240. In some embodiments, learning and rules module 280 may also obtain any data associated with the required computing processes from workflow engine 240. Learning and rule engine 282 may also obtain data associated with execution of the required computing processes, such as processor usage parameters, resource utilization parameters, etc., from computing resource optimizer 300 and/or watcher engine 340.

Rule engine 284 may identify one or more rules associated with executing the required computing processes. In some embodiments, rule engine 284 may store one or more rules associated with computing processes (e.g., a sentiment analysis, an ETL process, etc.) that are defined in execution strategy repository 260. For example, rule engine 284 may store one or more rules that define the allocation of computing resources for a particular computing process or a process flow. In some embodiments, rule engine 284 may provide the identified rules to learning and rule engine 282, which may enable the communication of the identified rules to other components of system 210 (e.g., computing resource optimizer 300) for allocating the computing resources to execute the required computing processes.

Real time updater 286 may collect data associated with performing the task-processing requests and update information stored the knowledge repository 290. For example, real time updater 286 may collect parameters such as processor usage parameters and resource utilization parameters (e.g., number of computing systems used, type of images used, total execution time etc.). As described above, some of the data may be provided by watcher engine 340. Real time updater 286 may also collect data from other components of system 210 (e.g., from workflow engine 240). Based on the data collected, real time update 286 may update information stored in knowledge repository 290.

Knowledge repository 290 may store information like historical learning information. Historical learning information may include data associated with performing past task-processing requests. Such data may be provided by, for example, workflow engine 240, computing resource optimizer 300, and/or watcher engine 340. The information stored in knowledge repository 290 may include, for example, parameters of the execution of the one or more computing processes, performance of the allocated computing resources in executing the computing processes, time consumed for executing the computing processes, number of machines or clusters used, type of images selected, number of computing processes selected, order of the computing processes, and/or any data associated with past or current execution of the computing processes. The information stored in knowledge repository 290 may be used for determining optimized infrastructures for performing future task-processing requests.

In some embodiments, decision module 292 may identify and access information stored in knowledge repository 290. For example, decision module 292 may identify the historical learning information to access based on the required computing processes. Based on the identified historical learning information, decision module 292 may provide decisions (e.g., configurations) associated with executing the required computing processes. For example, if an ETL process is required, decision module 292 may identify any historical learning information related to executing an ETL process (e.g., identify the machines or clusters that have ETL tools for executing an ETL process). Decision module 292 may provide configurations (e.g., the IP addresses of the machines or clusters that have ETL tools, number of machines of clusters, etc.) to learning and rules engine 282.

As described above, rules engine 284 may identify one or more rules associated with executing the required computing processes, and provide the rules to learning and rules engine 282. Decision module 292 may provide decisions (e.g., configurations) based on the historical learning information stored in knowledge repository 290. In some embodiments, learning and rules engine 282 may estimate the required computing resources for executing the one or more required computing processes based on one or both of the identified historical learning information and the one or more rules associated with executing the required computing processes.

As an example, a task-processing request may require executing of a log analyzing process. Learning and rules engine 282 may determine that the level of computing complexity of such a process is low and the data size associated with such computing process may be small. Accordingly, learning and rules engine 282 may estimate the required computing resources based on the rules provided by rules engine 284, and may determine that a small amount of computing resources is required for executing such process. As another example, a task-processing request may require executing of a plurality of computing process (e.g., a social media extraction process, an ETL process, and a sentiment analysis). The level of computing complexity may be high and the data size associated with such computing processes may be large. Accordingly, learning and rules engine 282 may estimate the required computing resources based on the historical learning information stored in knowledge repository 290, and may determine that a large amount of computing resources is required. In some embodiments, learning and rules engine 282 may estimate the required computing resources based on both the identified historical learning information and the rules associated with executing the required computing processes for performing the task-processing request. It is appreciated that learning and rule engine 282 may estimate the required computing resources using any desired information.

FIG. 2C is an exemplary functional block diagram of a computing resource optimizer 300, according to some embodiments of the present disclosure. Computing resource optimizer 300 may manage available computing resources (e.g., servers and clusters in machines and/or clusters 360). For example, based on the estimation of the required computing resources provided by learning and rule module 280, computing resource optimizer 300 may determine an optimized infrastructure for performing the task-processing request. Computing resource optimizer 300 may include an optimizer 302, a task progress monitor 304, a network map 306, and/or an optimization network graph 308.

An optimizer 302 may communicate with workflow engine 240 and/or learning and rules module 280. For example, optimizer 302 may obtain the required computing processes, the process flow, and/or any data associated with the required computing processes from workflow engine 240. In some embodiments, optimizer 302 may also obtain the estimated required computing resources from leaning and rules module 280. As described above, watcher engine 340 may monitor and provide the availability and/or parameters associated with the computing resources (e.g., machines and/or clusters 360) to computing resource optimizer 300. Optimizer 302 may thus obtain the operating status of the available computing resources including at least one of: current states of the available computing resources, one or more processor-related current utilization parameters, one or more memory-related current utilization parameters, one or more disk related current utilization parameters, and one or more network-related current traffic parameters.

Based on the obtained information, optimizer 302 may dynamically allocate computing resource for executing the required computing processes. For example, optimizer 302 may allocate a cluster of available servers that have the proper tools to execute the corresponding required computing processes. The cluster of available servers may be associated with IP addresses and optimizer 302 may allocate the servers by assigning a group of IP addresses representing the servers or, in some embodiments, virtual machines of one or more servers. After allocating the computing resources, optimizer 302 may determine the optimized infrastructure for performing the task-processing request. For example, optimizer 302 may determine that a particular server having social media extraction tools should be allocated to execute the required social media extraction process. Optimizer 302 may thus associate the IP address of the server or a virtual machine of the server to the required social media extraction process. Similarly, optimizer 302 may allocate another server or virtual machine having ETL tools to execute an ETL process.

As shown in FIG. 2C, computing resource optimizer 300 may include a task progress monitor 304. Task progress monitor 304 may monitor and provide the progress of executing the required computing processes. For example, task progress monitor 304 may provide information such as percentage of the computing process that is completed, remaining computing processes to be completed, etc.

Computing resource optimizer 300 may also include a network map 306. Network map 306 may provide the network architecture corresponding to the optimized infrastructure for performing a task-processing request. For example, the optimized infrastructure for performing a task-processing request may include computing resources such as one or more virtual machines, servers, and/or clusters. Network map 306 may obtain the information (e.g., IP addresses and/or other network identifications) of these computing resources and provide the network architecture of these computing resources in a format of a visual map, chart, table, or any other desired format. In some embodiments, network map 306 may maintain a repository of network architectures associated with one or more optimized infrastructures for performing various task-processing requests. Network map 306 may provide information in the repository to, for example, learning and rules module 280 for estimating required computing resources for performing future task-processing requests.

As shown in FIG. 2C, computing resource optimizer 300 may also include an optimization network graph 308. Optimization network graph 308 may provide information associated with the usability of computing resources. For example, optimization network graph 308 may provide a utilization percentage of the available computing resources (e.g., machines and/or clusters 360), efficiency of the computing resources, number of free nodes in the computing resources, non-performing or malfunctioning computing resources, and/or any other desired information.

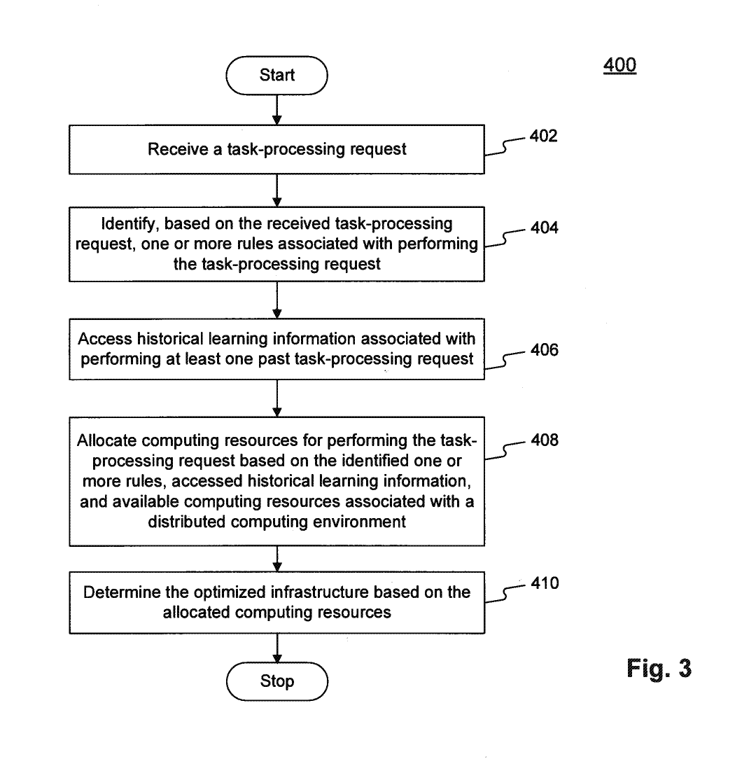

FIG. 3 is a flow diagram illustrating an exemplary method 400 for dynamically determining an optimized infrastructure for processing data, consistent with some embodiments of the present disclosure. With reference to FIG. 3, in some embodiments, a system (e.g., system 210) for dynamically determine an optimized infrastructure for processing data may receive a task-processing request (step 402). For example, the system may receive information associated with one or more computing processes, such as a social media extraction process, a crawling process, a data filtering process, an ETL process, a sentiment analysis, a user-defined process, etc.

The system may also receive information indicating the order of executing the computing processes. For example, the order of executing the computing processes indicated in the task-processing request may be executing first a social media extraction process, following by a crawling process, followed by a data filtering process, followed by an ETL process, followed by a sentiment analysis, followed by a user-defined process. The system may also receive a plurality of the task-processing requirements. For example, the system may receive detailed requirements associated with executing the one or more computing processes (e.g., specific parameters of the computing processes).

In some embodiments, the system may identify, based on the received task-processing request, one or more rules associated with performing the task-processing request (step 404). For example, the system may store and identify one or more rules that define the allocation of computing resources for executing a required computing process or a process flow.

The system may access historical learning information associated with performing at least one past task-processing request (step 406). For example, based on the required computing processes, the system may identify and access historical learning information stored in a knowledge repository (e.g., knowledge repository 290). Based on the identified historical learning information, the system may provide decisions (e.g., configurations) associated with executing the required computing processes. For example, if an ETL process is required, the system may identify any historical learning information related to executing an ETL process (e.g., identify the machines or clusters that have ETL tools for executing an ETL process). The system may provide configurations (e.g., the IP addresses of the machines or clusters that have ETL tools, number of machines of clusters, etc.) for allocating the computing resources.

The system may allocate computing resources for performing the task-processing request based on the identified one or more rules, accessed historical learning information, and/or available computing resources associated with a distributed computing environment (step 408). In some embodiments, prior to allocating the computing resources for performing the task-processing request, the system may estimate the required computing resources based on one or both of the identified rules and the accessed historical learning information. The estimation of the required computing resources will be further described below.

In some embodiments, the system may dynamically allocate computing resources for executing the required computing processes. For example, the system may allocate a cluster of available servers that have the proper tools to execute the corresponding required computing processes. The cluster of available servers may be associated with IP addresses and, therefore, the system may allocate the servers by assigning a group of IP addresses representing the servers or, in some embodiments, virtual machines of one or more servers.

After allocating the computing resources, the system may determine the optimized infrastructure for performing the task-processing request (step 410). For example, the system may determine that a particular server having social media extraction tools should be allocated to execute the required social media extraction process. The system may thus associate the IP address of the server or a virtual machine of the server to the required social media extraction process. Similarly, the system may allocate another server or virtual machine having ETL tools to execute an ETL process.

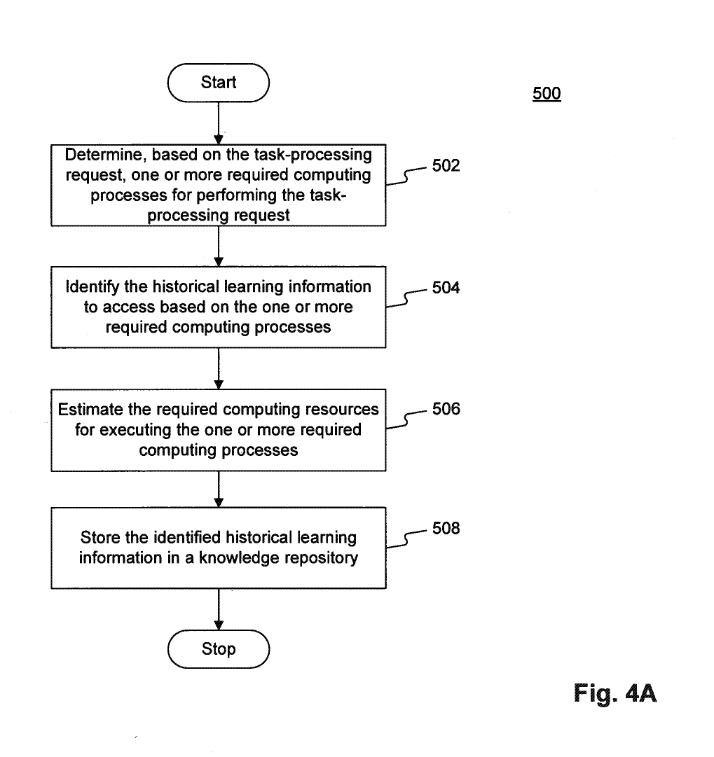

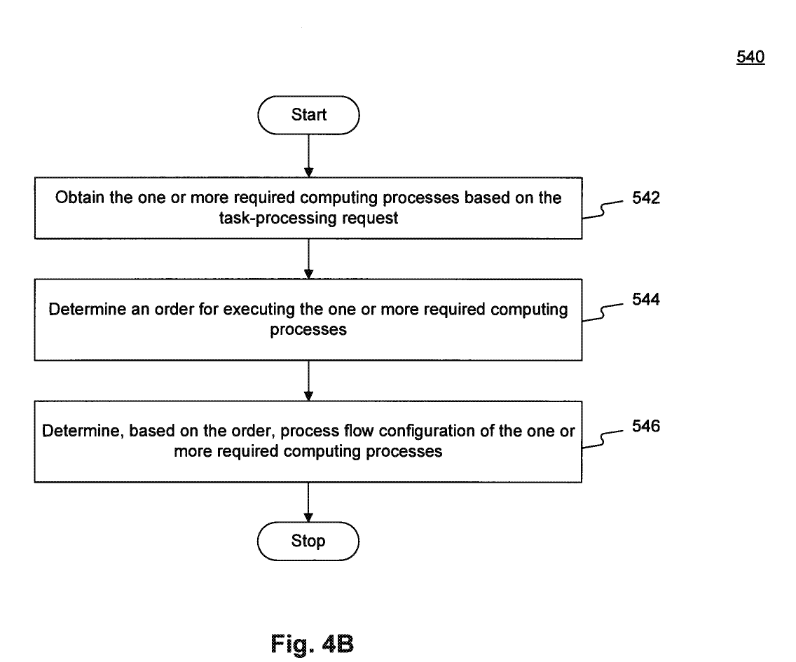

FIG. 4A is a flow diagram illustrating an exemplary method 500 for estimating required computing resources, consistent with some embodiments of the present disclosure. With reference to FIG. 4A, in some embodiments, the system may determine, based on the task-processing request, one or more required computing processes for performing the task-processing request (step 502). For example, the system may obtain information associated with the task-processing request, which may indicate one or more computing processes for performing the task-processing request, such as a social media extraction process, a crawling process, a data filtering process, an ETL process, a sentiment analysis, and/or a user-defined process. After obtaining such information, the system may determine that the one or more computing processes indicated in the information correspond to the available computing processes in an execution strategy repository (e.g., execution strategy repository 260). Step 502 will be further described below.

As shown in FIG. 4A, in some embodiments, the system may identify historical learning information to access based on the one or more required computing processes. Based on the identified historical learning information, the system may provide decisions (e.g., configurations) associated with performing the one or more required computing processes. For example, if an ETL process is required, the system may identify any historical learning information related to executing an ETL process (e.g., identify the machines or clusters that have ETL tools for executing an ETL process). The system may provide configurations, such as the IP addresses of the machines or clusters that have ETL tools, number of machines of clusters, etc.

In some embodiments, after identifying historical learning information, the system may estimate the required computing resources for executing the one or more required computing processes based on at least one of the identified historical learning information and the one or more rules associated with performing the task-processing request (step 506). As an example, a task-processing request may require executing a log analyzing process. The system may determine that the level of computing complexity of such process is low and the data size associated with such computing process may be small. Accordingly, the system may estimate the required computing resources based on the rules associated with executing the required computing processes, and may determine that a small amount of computing resources is required for executing such process. As another example, a task-processing request may require executing of a plurality of computing process (e.g., a social media extraction process, an ETL process, and a sentiment analysis). The level of computing complexity may be high and the data size associated with such computing processes may be large. Accordingly, the system may estimate the required computing resources based on the historical learning information stored in a knowledge repository, and may determine that a large amount of computing resources is required. In some embodiments, the system may estimate the required computing resources based on both the identified historical learning information and the rules associated with executing the required computing processes for performing the task-processing request. It is appreciated that the system may estimate the required computing resources using any desired information.

With reference to FIG. 4A, in some embodiments, the system may store the identified historical learning information in a knowledge repository (step 508). Historical learning information may include data associated with performing past task-processing requests. The information stored in the knowledge repository may include, for example, parameters of the execution of the one or more computing processes, performance of the allocated computing resources in executing the computing processes, time consumed for executing the computing processes, number of machines or clusters used, type of images selected, number of computing processes selected, order of the computing processes, and/or any data associated with past or current execution of one or more computing processes. The information stored in the knowledge repository may be used for determining optimized infrastructures for performing future task-processing requests.

FIG. 4B is a flow diagram illustrating an exemplary method 540 for determining the required computing processes, consistent with some embodiments of the present disclosure. With reference to FIG. 4B, in some embodiments, the system may obtain the one or more required computing processes based on the task-processing request (step 542). For example, the system may obtain the information associated with the task-processing request. The information may indicate one or more computing processes for performing the task-processing request. After obtaining such information, the system may determine that the one or more computing processes indicated in the information correspond to the available computing processes in an execution strategy repository. For example, the system may receive a task-processing request including descriptions or selections of a social media extraction process and sentiment analysis. Based on the descriptions or selections, the system may determine that the social media extraction process and the sentiment analysis correspond to available computing processes as indicated by the execution strategy repository.

In some embodiments, the system may determine an order of executing the one or more required computing processes determined available (step 544). For example, the system may determine that the computing processes indicated in the task-processing request correspond to the sentiment analysis, the data filtering process, and the social media extraction process, all three of which are available processes and are required computing processes for performing the task-processing request. The information associated with the task-processing request may also indicate the order of executing the one or more required computing processes. Based on the information, the system may determine that the order of executing these required computing processes are to execute the social media extraction process first, followed by the data filtering process, and followed by the sentiment analysis.

In some embodiments, the system may also determine the process flow configuration (e.g., connections of the inputs and outputs of the computing processes) (step 546). For example, the system may determine that the output of the social media extraction process should be the input of the data filtering process, and the output the data filtering process should be the input of the sentiment analysis. In some embodiments, the input and/or output of one required computing process may also be connected to the input and/or output of two or more required computing processes. For example, the output a data filtering process may be connected to the input of a sentiment analysis and the input of an ETL process.

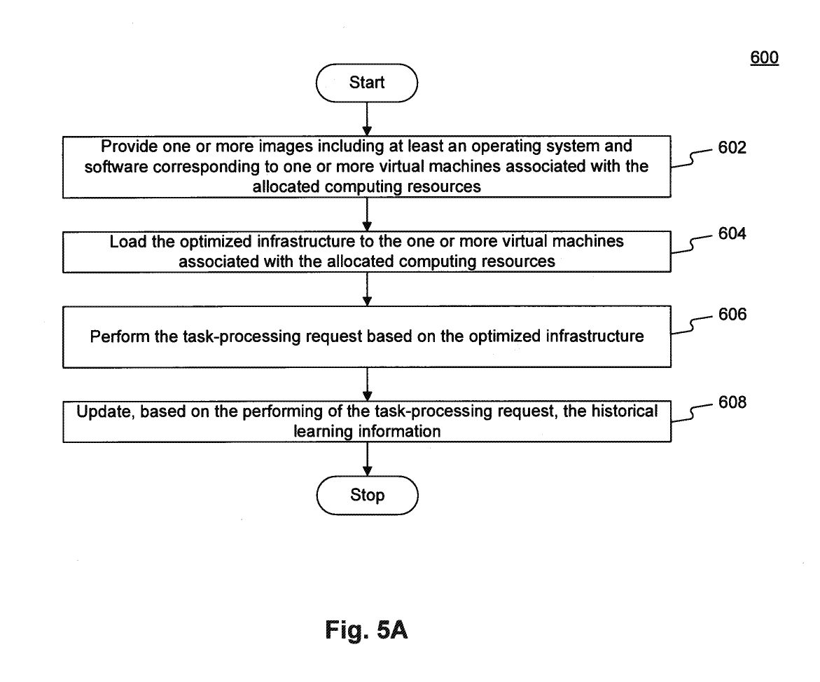

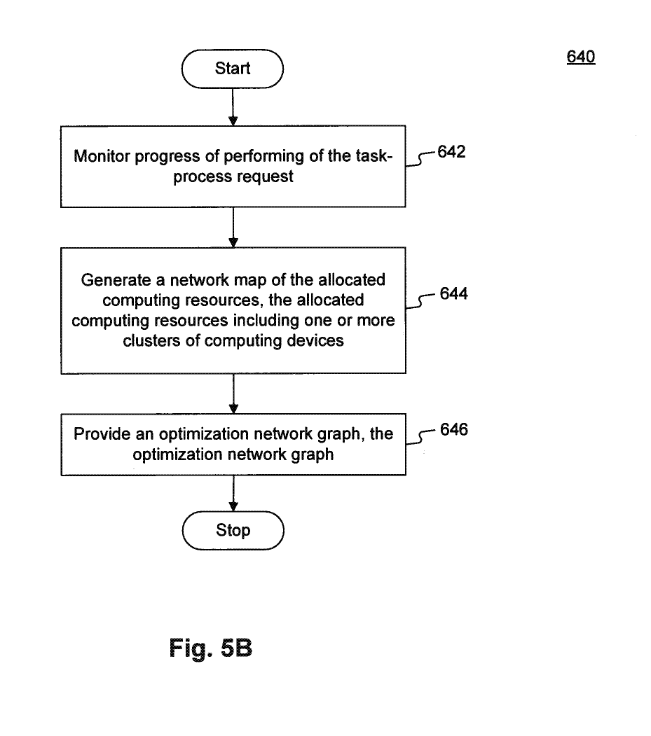

FIG. 5A is a flow diagram illustrating an exemplary method 600 for providing an optimized infrastructure, consistent with some embodiments of the present disclosure. With reference to FIG. 5A, the system may provide one or more images including at least an operating system and software corresponding to one or more virtual machines associated with the allocated computing resources (step 602). In some embodiments, the system may obtain the optimized infrastructure. Based on the optimized infrastructure, which may indicate the allocation of the computing resources, the system may provide images to the allocated computing resources. The provided images may include, for example, operating systems and software corresponding to the virtual machines of allocated computing resources. The software may be, for example, Hadoop ecosystem, SQL databases, NoSQL databases, etc. In some embodiments, the system may provide images including the software installed with the operating systems.

In some embodiments, after providing the images, the system may load the optimized infrastructure to one or more virtual machines associated with the allocated computing resources (step 604). For example, the system may boot the correct images to the allocated computing resources (e.g., virtual machines of a plurality of servers) and load the optimized infrastructure to the allocated computing resources. The optimized infrastructure may indicate, for example, the one or more required computing processes and their corresponding allocated virtual machines/servers/clusters. The system may also request the allocated computing resources to execute the one or more required computing processes for performing the task-processing request (step 606).

With reference to FIG. 5A, in some embodiments, the system may update, based on the performing of the task-processing request, the historical learning information (step 608). For example, the system may collect data associated with performing task-processing requests and update information stored the knowledge repository. The system may collect parameters such as processor usage parameters and resource utilization parameters (e.g., number of computing systems used, type of images used, total execution time, etc.). Based on the data collected, the system may update historical learning information stored in the knowledge repository for future use.

FIG. 5B is a flow diagram illustrating an exemplary method 640 for performing the task-processing request using an optimized infrastructure, consistent with some embodiments of the present disclosure. With reference to FIG. 5B, in some embodiments performing the data-process request, the system may perform at least one of: monitoring progress of performing of the data-process request (step 642), generating a network map of the allocated computing resources (step 644), and providing an optimization network graph (step 646). The optimization network graph may indicate at least one of: a utilization percentage of the one or more clusters, an efficiency of the one or more clusters, a number of free nodes in the one or more clusters, or one or more non-operating computing devices.

At step 642, the system may monitor progress of the performance of the data-process request. For example, the system may monitor and provide the progress of performing the one or more required computing processes. The system may provide information such as percentage of the computing process that is completed, remaining computing processes to be completed, etc.

In some embodiments, the system may generate a network map of the allocated computing resources (step 644). For example, the system may provide the network architecture of the optimized infrastructure for performing a particular task-processing request. The optimized infrastructure for performing a task-processing request may include computing resources, such as one or more virtual machines, servers, or clusters. The system may obtain the information (e.g., IP addresses or other network identification) of these computing resources and provide the network architecture of these computing resources in a format of a visual map, chart, table, or any other desired format. In some embodiments, the system may maintain a repository of network architectures associated with optimized infrastructures for performing various task-processing requests. The system may provide information stored in the repository for estimating required computing resources for performing future task-processing requests.

As shown in FIG. 5B, the system may also provide an optimization network graph (step 646). The optimization network graph may provide information associated with the usability of computing resources. For example, the optimization network graph may provide utilization percentage of the available computing resources, efficiency of the computing resources, number of free nodes in the computing resources, non-performing/malfunctioning computing resources, and/or any other desired information.

One or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A system for dynamically determining an optimized infrastructure for processing data, comprising:
one or more hardware processors; and
a memory storing processor-executable instructions comprising instructions for:
receiving a task-processing request;
identifying, based on the received task-processing request, one or more rules associated with performing the task-processing request;
accessing historical learning information associated with performing at least one past task-processing request;
allocating computing resources for performing the task-processing request based on the identified one or more rules, accessed historical learning information, and available computing resources associated with a distributed computing environment; and
determining the optimized infrastructure based on the allocated computing resources.

2. The system of claim 1, wherein the distributed computing environment comprises at least one of: a computing device configured for virtual processing, a cluster computing environment, or a grid computing environment.

3. The system of claim 1, wherein receiving the task-processing request comprises receiving at least one of:
information associated with one or more computing processes for performing the task-processing request;
an order of execution with respect to the one or more computing processes; or
a plurality of task-processing requirements.

4. The system of claim 3, wherein the one or more computing processes comprise at least one of: a sentiment analysis, a data filtering process, an extract-transform-load (ETL) process, a log analyzing process, a social media extraction process, a recommendation process, a crawling process, or a user-defined process.

5. The system of claim 1, wherein the historical learning information comprises at least one of: a number of computing devices or clusters used for performing the at least one past task-processing request, a number of images associated with virtual machines executed on the computing devices or clusters, one or more types of the images associated with the virtual machines, a number of computing processes associated with the at least one past task-processing request, a time for performing the at least one past task-processing request, an order for executing the computing processes associated with the at least one past task-processing request, or performance of performing at least one of the past task-processing request.

6. The system of claim 1, wherein the memory stores processor-executable instructions further comprising instructions for:
determining, based on the task-processing request, one or more required computing processes for performing the task-processing request;
identifying the historical learning information to access based on the one or more required computing processes;
estimating the required computing resources for executing the one or more required computing processes based on at least one of the identified historical learning information and the one or more rules associated with performing the task-processing request; and
storing the identified historical learning information in a knowledge repository.

7. The system of claim 6, wherein determining the one or more required computing processes comprises:
obtaining the one or more required computing processes based on the task-processing request;
determining an order for executing the one or more required computing processes; and
determining, based on the order, process flow configuration corresponding to the one or more required computing processes.

8. The system of claim 1, wherein allocating the computing resources for performing the task-processing request comprises:
determining an operating status of the available computing resources of the distributed computing environment, the operating status including at least one of: current states of the available computing resources, one or more processor-related current utilization parameters, one or more memory-related current utilization parameters, one or more disk related current utilization parameters, and one or more network-related current traffic parameters; and
allocating the computing resources based on the operating status.

9. The system of claim 1, further comprising:
providing one or more images including at least an operating system and software corresponding to one or more virtual machines associated with the allocated computing resources;
loading, based on the one or more images, the optimized infrastructure to the one or more virtual machines associated with the allocated computing resources;
performing the task-processing request based on the optimized infrastructure; and
updating, based on the performing of the task-processing request, the historical learning information.

10. The system of claim 9, wherein performing the task-processing request comprises:
monitoring progress of performing of the task-processing request;
generating a network map of the allocated computing resources, the allocated computing resources including one or more clusters of computing devices; and
providing an optimization network graph, the optimization network graph including at least one of: a utilization percentage of the one or more clusters, an efficiency of the one or more clusters, a number of free nodes in the one or more clusters, or one or more non-operating computing devices.

11. A method for dynamically determining an optimized infrastructure for processing data, comprising:
receiving a task-processing request;
identifying, based on the received task-processing request, one or more rules associated with performing the task-processing request;
accessing historical learning information associated with performing at least one past task-processing request;
allocating computing resources for performing the task-processing request based on the identified one or more rules, accessed historical learning information, and available computing resources associated with a distributed computing environment; and
determining the optimized infrastructure based on the allocated computing resources.

12. The method of claim 11, wherein the distributed computing environment comprises at least one of: a computing device configured for virtual processing, a cluster computing environment, or a grid computing environment.

13. The method of claim 11, wherein receiving the task-processing request comprises receiving at least one of:
information associated with one or more computing processes for performing the task-processing request;
an order of execution with respect to the one or more computing processes; or
a plurality of task-processing requirements.

14. The method of claim 13, wherein the one or more computing processes comprise at least one of: a sentiment analysis, a data filtering process, an extract-transform-load (ETL) process, a log analyzing process, a social media extraction process, a recommendation process, a crawling process, or a user-defined process.

15. The method of claim 11, wherein the historical learning information comprises at least one of: a number of computing devices or clusters used for performing the at least one past task-processing request, a number of images associated with virtual machines executed on the computing devices or clusters, one or more types of the images associated with the virtual machines, a number of computing processes associated with the at least one past task-processing request, a time for performing the at least one past task-processing request, an order for executing the computing processes associated with the at least one past task-processing request, or performance of performing at least one of the past task-processing request.

16. The method of claim 11, further comprising:
determining, based on the task-processing request, one or more required computing processes for performing the task-processing request;
identifying the historical learning information to access based on the one or more required computing processes;
estimating the required computing resources for executing the one or more required computing processes based on at least one of the identified historical learning information and the one or more rules associated with performing the task-processing request; and
storing the identified historical learning information in a knowledge repository.

17. The method of claim 16, wherein determining the one or more required computing processes comprises:
obtaining the one or more required computing processes based on the task-processing request;
determining an order for executing the one or more required computing processes; and
determining, based on the order, process flow configuration corresponding to the one or more required computing processes.

18. The method of claim 11, wherein allocating the computing resources for performing the task-processing request comprises:
determining an operating status of the available computing resources of the distributed computing environment, the operating status including at least one of: current states of the available computing resources, one or more processor-related current utilization parameters, one or more memory-related current utilization parameters, one or more disk related current utilization parameters, and one or more network-related current traffic parameters; and
allocating the computing resources based on the operating status.

19. The method of claim 11, further comprising:
providing one or more images including at least an operating system and software corresponding to one or more virtual machines associated with the allocated computing resources;
loading, based on the one or more images, the optimized infrastructure to the one or more virtual machines associated with the allocated computing resources;
performing the task-processing request based on the optimized infrastructure; and
updating, based on the performing of the task-processing request, the historical learning information.

20. The method of claim 19, wherein performing the task-processing request comprises at least one of:
monitoring progress of performing of the task-processing request;
generating a network map of the allocated computing resources, the allocated computing resources including one or more clusters of computing devices; and
providing an optimization network graph, the optimization network graph including at least one of: a utilization percentage of the one or more clusters, an efficiency of the one or more clusters, a number of free nodes in the one or more clusters, or one or more non-operating computing devices.

21. A non-transitory computer program medium having embodied thereon computer program instructions for dynamically determining an optimized infrastructure for processing data, the computer program medium storing instructions that, when executed by one or more processors, cause the one or more processors to operations comprising:
receiving a task-processing request;
identifying, based on the received task-processing request, one or more rules associated with performing the task-processing request;
accessing historical learning information associated with performing at least one past task-processing request;
allocating computing resources for performing the task-processing request based on the identified one or more rules, accessed historical learning information, and available computing resources associated with a distributed computing environment; and
determining the optimized infrastructure based on the allocated computing resources.

22. The computer program medium of claim 21, the distributed computing environment comprises at least one of: a computing device configured for virtual processing, a cluster computing environment, or a grid computing environment.

23. The computer program medium of claim 21, wherein receiving the task-processing request comprises receiving at least one of:
information associated with one or more computing processes for performing the task-processing request;
an order of execution with respect to the one or more computing processes; or
a plurality of task-processing requirements.

24. The computer program medium of claim 23, wherein the one or more computing processes comprise at least one of: a sentiment analysis, a data filtering process, an extract-transform-load (ETL) process, a log analyzing process, a social media extraction process, a recommendation process, a crawling process, or a user-defined process.

25. The computer program medium of claim 21, wherein the historical learning information comprises at least one of: a number of computing devices or clusters used for performing the at least one past task-processing request, a number of images associated with virtual machines executed on the computing devices or clusters, one or more types of the images associated with the virtual machines, a number of computing processes associated with the at least one past task-processing request, a time for performing the at least one past task-processing request, an order for executing the computing processes associated with the at least one past task-processing request, or performance of performing at least one of the past task-processing request.

26. The computer program medium of claim 21, further comprising instructions for:
determining, based on the task-processing request, one or more required computing processes for performing the task-processing request;
identifying the historical learning information to access based on the one or more required computing processes;
estimating the required computing resources for executing the one or more required computing processes based on at least one of the identified historical learning information and the one or more rules associated with performing the task-processing request; and
storing the identified historical learning information in a knowledge repository.

27. The computer program medium of claim 26, wherein determining the one or more required computing processes comprises:
obtaining the one or more required computing processes based on the task-processing request;
determining an order for executing the one or more required computing processes; and
determining, based on the order, process flow configuration corresponding to the one or more required computing processes.

28. The computer program medium of claim 21, wherein allocating the computing resources for performing the task-processing request comprises:
determining an operating status of the available computing resources of the distributed computing environment, the operating status including at least one of: current states of the available computing resources, one or more processor-related current utilization parameters, one or more memory-related current utilization parameters, one or more disk related current utilization parameters, and one or more network-related current traffic parameters; and
allocating the computing resources based on the operating status.

29. The computer program medium of claim 21, further comprising instructions for:
providing one or more images including at least an operating system and software corresponding to one or more virtual machines associated with the allocated computing resources;
loading, based on the one or more images, the optimized infrastructure to the one or more virtual machines associated with the allocated computing resources;
performing the task-processing request based on the optimized infrastructure; and
updating, based on the performing of the task-processing request, the historical learning information.

30. The computer readable medium of claim 29, wherein performing the task-processing request comprises:
monitoring progress of performing of the task-processing request;
generating a network map of the allocated computing resources, the allocated computing resources including one or more clusters of computing devices; and
providing an optimization network graph, the optimization network graph including at least one of: a utilization percentage of the one or more clusters, an efficiency of the one or more clusters, a number of free nodes in the one or more clusters, or one or more non-operating computing devices.
